(19) United States
(12) Patent Application Publication
(10) Pub. No.: US 2007/0244246 A1
(43) Pub. Date: Oct. 18, 2007

(54) Paint compositions containing an additive to reduce the effect of viscosity loss caused by the addition of colorants

(75) Inventors: Mark A. Paczkowski, Andover, NJ (US); Chunzhao Li, Hightstown, NJ (US)

Correspondence Address: MORGAN, LEWIS & BOCKIUS LLP, 1701 MARKET STREET, PHILADELPHIA, PA, 19103-2921, US

(73) Assignee: Elementis Specialties, Inc.

(21) Appl. No.: 11/810,935

(22) Filed: Jun. 7, 2007

Related U.S. Application Data
(63) Continuation of application No. 11/517,692, filed on Sep. 7, 2006.
(60) Provisional application No. 60/812,069, filed on Jun. 7, 2006.
(60) Provisional application No. 60/714,946, filed on Sep. 7, 2005.

(51) Int. Cl. C08G 18/42

(52) U.S. Cl. 524/500

(57) ABSTRACT

A water-borne latex paint system and a method of formulating a water borne latex paint system having viscosity color stability. The system includes a base paint, at least one associative thickener, a colorant compound, and at least 0.1% dry weight of a block copolymer ABLBA composition. The block copolymer acts as a viscosity stabilizer in the presence of associative thickeners. The A component includes a monomer unit containing a moiety such as an alkyl group, an aryl group or an alkyl aryl group; the B component includes a polyethylene oxide polymer or a polyethylene-polypropylene oxide copolymer; and the L component includes a dianhydride unit or a diisocyanate unit.

### RELATED APPLICATIONS

This application claims the benefit of U.S. Provisional Application No. 60/812,069, filed on Jun. 7, 2006, entitled “Improved Paint Compositions Containing an Additive to Reduce the Effect of Viscosity Loss caused by the Addition of Colorants”. This application is a continuation in part of U.S. patent application Ser. No. 11/517,692, filed Sep. 7, 2006, entitled “Improved Paint Compositions Containing an Additive to Reduce the Effect of Viscosity Loss caused by the Addition of Colorants” which claims the benefit of U.S. Provisional Application No. 60/714,946, filed Sep. 7, 2005, entitled “Improved Paint Compositions Containing an Additive to Reduce the Effect of Viscosity Loss caused by the Addition of Colorants,” each of which is incorporated herein by reference in its entirety.

### FIELD OF THE INVENTION

The present invention relates to an improved paint compositions and, more particularly, to an additive composition to be used in water-borne latex paints to reduce the disruption of an associative thickener network upon the addition of colorants, as well as a novel process for producing the improved paint compositions.

### SUMMARY OF THE INVENTION

In one embodiment, this invention relates to improved paint compositions containing an additive to reduce the effect of viscosity loss caused by the addition of colorants.

One aspect of the invention relates to a water-borne latex paint system, comprising a base paint, at least one associative thickener, a colorant compound, and at least 0.1% dry weight of a block copolymer ABLBA composition. The block copolymer acts as a viscosity stabilizer in the presence of associative thickeners. The A component includes a monomer unit containing a moiety such as an alkyl group, an aryl group or an alkyl aryl group. The B component includes a polyethylene oxide polymer or a polyethylene-polypropylene oxide copolymer. The L component includes a dianhydride unit or a diisocyanate unit.

Another aspect of the invention relates to a method of formulating a water-borne latex paint system, comprising adding to a base paint, an associative thickener and a colorant compound and further adding at least 0.1% dry weight of a block copolymer ABLBA composition.

Yet another aspect of the invention relates to a polymer chemical. The polymer chemical is prepared by reacting a monomer unit containing a moiety such as an alkyl group, an aryl group or an alkyl aryl group, a polyethylene oxide polymer or a polyethylene-polypropylene oxide copolymer; and an L component such as a dianhydride unit and a diisocyanate unit.

### BRIEF DESCRIPTION OF DRAWINGS

FIG. 1 illustrates the concentration effect of a viscosity stabilizer upon the addition of a colorant to a paint formulation for an embodiment of the present invention.

### DESCRIPTION OF THE EMBODIMENTS

In certain water based paint systems, it is desirable to maintain the paint's mid-shear (or Stormer) viscosity by ±10% of its base value. The extent of the viscosity drop observed with the addition of colorant depends on the efficiency of the associative thickener—i.e. the amount of thickener needed to obtain a predetermined viscosity—and usually, the more efficient the associative thickener, the larger the drop in the observed viscosity. As an example of the extent of the mid-shear viscosity decrease upon tinting, it is not unusual to observe a −30 to −40 KU (Krebs Unit—Stormer viscosity units) drop in a 90-100 KU paint. This kind of viscosity reduction results in a very fluid paint creating coating problems. The viscosity drop is related to the composition of the tinting formulation. This is most likely due to the quantity and type of surfactants used to stabilize the pigment in the colorant. In most cases, carbon black requires the most surfactant and therefore is the most troublesome color.

In one embodiment, the present invention provides for a system and method to formulate a water-borne latex paint system which reduces the viscosity drop until the addition of tint to the base paint formulation. The water-borne latex paint system includes a base paint, at least one associative thickener, a colorant compound, and at least 0.1% dry weight of a block copolymer ABLBA composition. In one embodiment, the ABLBA-type polymer includes: an A component comprising a hydrophobic group A; a B component comprising a hydrophilic polymer B; and an L component comprising a linking group. The ABLBA copolymer functions as a viscosity stabilizer in the water-borne latex paint systems.

In one embodiment, the hydrophobic group A component, of the ABLBA polymer, includes a monomer unit containing a moiety such as an alkyl group, an aryl group or an alkyl aryl group. In certain embodiments, the hydrophobic group A component includes linear C₁₀-C₂₂ alcohols, branched C₁₂-C₂₄ alcohols and mixtures thereof. In certain other embodiments, the hydrophobic group A component includes 2-butyl-octanol, 2-hexyl-decanol, 2-octyl-dodecanol, 2-isoheptyl-7-methyl-undecanol, 2-(2,4,4-trimethylbutyl)-6,8,8-trimethyl-nonanol, and mixtures thereof. In one embodiment, the hydrophobic group A component includes 2-hexyl decanol.

In one embodiment, the B component, of the ABLBA polymer, includes a polyethylene oxide polymer or a polyethylene-polypropylene oxide copolymer. In certain embodiments, the polyethylene oxide polymer has from 25 to 100 ethylene oxide repeat units. In certain other embodiments, the polyethylene-polypropylene oxide copolymer has a total number of repeat units ranging from 25 to 75 and up to 10 propylene oxide units. In one embodiment, the polyethylene-polypropylene oxide copolymer has a number average molecular weight less than 2500. In another embodiment, the B component includes polyethylene oxide having 50 ethylene oxide units.

The AB ethoxylate may be synthesized by reacting the A and B components in a basic solution or in the presence of a metal catalyst. In one embodiment, the AB ethoxylate has a number average molecular weight below 3000 g/mole. In another embodiment, the AB ethoxylate has a number average molecular below less than 2500 g/mole.

In one embodiment, the L component, of the ABLBA polymer, includes one or more linking units such a diisocyanate unit. In certain embodiments, the diisocyanate linking unit is generated from compounds such as hexamethylene diisocyanate (“HDI”), trimethyl hexamethylene diisocyanate (“TMDI”), isophorone diisocyanate (“IPDI”), tetramethyl xylene diisocyanate (“TMXDI”), and 4,4-methylene bis(cyclohexylisocyanate). In one embodiment, the diisocyanate linking unit is generated from hexamethylene diisocyanate. For these reactions, a catalyst such as an organo-tin or bismuth ester or an arnine is typically added to accelerate the reaction at the desired temperature. Because the temperature affects the degree of branching in urethane reactions and therefore the stoichiometry of the reaction, the reactions are performed at the lowest practical temperatures.

In another embodiment, the L component, of the ABLBA polymer, includes linking unit such as a dianhydride unit. In certain embodiments, the dianhydride is generated from compounds such as benzophenone tetracarboxylic dianhydride (BTD) or pyromellitic dianhydride (PMA) to give the corresponding diester polymer. The synthetic procedure for the dianhydride is similar to the diisocyanate procedure with an amine (triethylamine, DABCO, etc.) used as a catalyst. The resulting polymers have an anionic nature to them, which can be useful in some applications.

In one embodiment, the ABLBA polymer has number average molecular weight below 10,000 g/mole. In another embodiment, the ABLBA polymer has a number average molecular weight less than 7000 g/mole. The ABLBA has a hydrophobe-lipophile balance (HLB) value of greater than 15.

The base paint formulation also includes a resin. In certain embodiments, the resin includes a hydrophobic resin. Representative hydrophobic resins include an acrylic resin, a styrene acrylic resin or a styrene resin. In certain other embodiments, the resin includes a hydrophilic resin. Representative examples of hydrophilic resins include a vinyl acrylic resin or a vinyl acetate ethylene resin. In certain embodiments, the resin has a substantially spherical shape and a large particle size or low surface area. In one embodiment, the particle size may be greater than 200 nm. In another embodiment, the particle size ranges from 220 nm to 650 nm. In certain other embodiments, the resin has a substantially spherical shape and small particle size or high surface area. In one embodiment, the particle size may be less than 200 nm. In another embodiment, the particle size ranges from 80 nm to 180 nm. In still another embodiment, the resin has a multilobe shape. Representative resins includes Optive 130 (BASF, acrylic, 160 nm), UCAR 300 (Dow, vinyl acrylic, 260 nm), UCAR 625 (Dow, acrylic, 340 nm), Rhoplex ML-200 (Rohm & Haas, acrylic, 590 nm multilobe), and Neocryl XK-90 (DSM Neoresins, acrylic, 90 nm).

The water borne latex paint system may also include at least one associative thickener. Associative thickeners are water soluble or water swellable polymers that have chemically attached hydrophobic groups. The ABLBA stabilizer is effective in improving the viscosity stability to colorant addition for paints containing at least one associative thickener. In certain embodiments, the associative thickeners includes nonionic hydrophobically modified materials such as polyether and/or polyurethane associative thickeners or ionic associative thickeners such as hydrophobically modified alkali swellable (or soluble) emulsions (HASE) and hydrophobically modified hydroxyethyl cellulose and mixtures thereof. The number average molecular weights of the associative thickeners may range from 10,000 to 150,000 g/mole. In certain embodiments, two associative thickener compositions, a low shear thickener and a high shear thickener, may be used in combination with the ABLBA stabilizer. In one embodiment, the two associative thickeners may both have a composition of polyether polyurethane. In another embodiment, the two associative thickeners may both have a composition of polyether polyacetal. In yet another embodiment, one associative thickener has a composition of polyether and the second associative thickener has a composition of polyether polyurethane. Representative associative thickener pairs include Rohm & Haas Acrysol RM 825/RM 2020 NPR, Rohm & Haas Acrysol SCT 275/RM 2020 NPR, Aqualon NLS 200/NHS 300, Elementis Rheolate 255/350 and Cognis DSX 1514/DSX 3075. In certain other embodiments, a high shear thickener composition may be used in combination with the ABLBA stablizer. In one embodiment, the associative thickener has a composition of hydrophobically modified polyether polyurethane. In another embodiment, the associative thickener has a composition of a hydrophobically modified polyether polyacetal. In yet another embodiment, the associative thickener has a composition of hydrophobically modified polyether.

In certain embodiments where the resin has a particle size less than 200 nm, the ABLBA stabilizing polymers may be used in combination with a high shear thickener and act as a low shear thickener. In certain embodiments where the resin has a particle size greater than 200 nm, the ABLBA stabilizing polymers may be used in combination with a high shear thickener and a low shear thickener.

In one embodiment, the water borne latex paint system may contain less than 0.01 wt. % of a second polymer containing at least one hydrophilic group having a number average molecular weight of at least 1000 and only one hydrophobic group.

The ABLBA stabilizer may be added to the paint as a solid or as a liquid solution with other solvents and surfactants. In certain embodiments, the co-solution of the ABLBA stabilizer with other surfactants may make the ABLBA stabilizer less effective and therefore greater quantities of ABLBA stabilizer may be required to obtain the same performance. In a solid form, in one embodiment, the ABLBA stabilizer is added to the paint formulation with the colorant and then the material is dispersed for example with a high speed disperser or on a Red Devil shaker. In a liquid form, in certain embodiments, the ABLBA stabilizer is added at any stage of the paint preparation. In one embodiment, the ABLBA stabilizer is added to the base paint formulation. In another embodiment, the ABLBA stabilizer is added to the colorant.

### Synthesis of ABLBA Stabilizers

General Synthesis of Stabilizing Additive with Diisocyanate in Solvent.

To a 500 ml kettle fitted with a condenser, Dean Stark trap, nitrogen purge and an overhead stirrer is added 350 ml of dry toluene. 0.03 moles of lauryl ethoxylate (50) is the added to the kettle and the material is dissolved in the toluene at 75° C. The temperature is increased to ˜115° C. and water is then removed through azeotropic distillation until approximately 100 ml of toluene/water is separated. The reaction is cooled to 75° C. and 0.015 moles of hexamethylene diisocyanate is added over 5 minutes. (To accelerate the reaction 3 drops of dibutyl tin dilaurate may be added). The reaction mixture is stirred at 75° C. for 1 hour or until all of the isocyanate is consumed. The solution is cooled and the toluene is removed to give the desired polymer solid.

General Synthesis of Stabilizing Additive with Diisocyanate in the Absence of Solvent

0.06 moles of 2-hexyl-decanol ethoxylate (25) are added to a 250 ml three-neck round bottom flask fitted with an overhead stirrer, a vacuum adapter and a nitrogen purge. The flask is heated to 75° C. and the ethoxylate melts. 10 ml of dry toluene is added and the solution is stirred for 5 minutes at 200 RPM. The flask is evacuated and purged with nitrogen at about 100 ml/min so that a balance of pressure in the flask is maintained at −27 to −28 inches of Hg. The mixture is purged under these conditions for 2 hours. The vacuum is removed and the system is purged with nitrogen until atmospheric pressure is attained. Then 0.03 mole of hexamethylene diisocyanate is added to the flask over a period of 5 minutes. (If a catalyst is required, then 3 drops of dibutyl tin dilaurate is added at this point). The reaction is stirred at 75° C. for 30 minutes or until all of the isocyanate is consumed.

General Synthesis of Stabilizing Additive with Dianhydride in Solvent

To a 500 ml kettle fitted with a condenser, Dean Stark trap, nitrogen purge and an overhead stirrer is added 350 ml of dry toluene. 0.03 moles of the desired 2-hexyl-decanol ethoxylate (50) is then added to the kettle and the material is dissolved in the toluene at 75° C. The water is then removed through azeotropic distillation and approximately 100 ml of toluene/water is separated. The reaction is cooled to 75° C. and 0.015 moles of benzophenone tetracarboxylic dianhydride (Aldrich) is added all at once. 0.03 moles of triethylamine are then added to the mixture and the mixture is stirred at 75° C. for 16 hours or until all of the anhydride is consumed. The solution is cooled and the toluene and triethylamine is by removed by vacuum to give the desired polymer solid.

For a pourable additive, the solid additive can be put into solution with butyl carbitol and water. A typical additive formulation is a 25 weight % solution of the polymer with 10-15% butyl carbitol and 60-65% water.

Using the synthetic procedure conducted in solvent, a number of stabilizers having different A, B components, and hexamethylene diisocyanate as the linking unit were synthesized as shown in Table 1.

TABLE 1

| | | | Number |
|---|---|---|---|
| | | B | Average |
| | | component | MW of |
| | | EO/PO | ABLBA |
| Example | A component | Units | polymer |
| 1 | lauryl | 50/0 | 5600 |
| 2 | 2-hexyl-decyl | 50/0 | 5800 |
| 3 | 2-hexyl-decyl | 35/0 | 4300 |
| 4 | 2-hexyl-decyl | 40/0 | 5300 |
| 5 | 2-hexyl-decyl | 45/3 | 5900 |
| 6 | 2-octyl-dodecyl | 35/0 | 4400 |
| 7 | 2-octyl-dodecyl | 50/0 | 6000 |
| 8 | octadecyl | 23/0 | 2200 |
| 9 | nonylcyclohexyl | 50/0 | 5800 |

In order to assess the ability of the stabilizing polymers to reduce the viscosity drop observed in waterborne latex paints, five formulations were prepared with different resin systems. The resins used span a range of hydrophobicity and particle size which is related to the surface area. Represenative resins include Optive 130 (BASF, acrylic, 160 nm), UCAR 300 (Dow, vinyl acrylic, 260 nm), UCAR 625 (Dow, acrylic, 340 nm), Rhoplex ML-200 (Rohm & Haas, acrylic, 590 nm multilobe), and Neocryl XK-90 (DSM Neoresins, acrylic, 90 nm).

Because the extent of the viscosity problem is proportional to the amount of colorant added, a deep tint formulation was chosen. The formulation has low titanium dioxide levels and requires up to 12 fl. oz. of colorant per gallon of paint. A universal black colorant typically results in the largest viscosity loss. Therefore, the equivalent of 12 fl. oz./gal of Colortrend 888 Lamblack (Degussa) was used as the colorant, unless otherwise specified.

All of the paint formulations were thickened predominately with associative thickeners to maximizer the viscosity drop effect. In below examples, commercially available thickener pairs (low shear/high shear) were used such as Rohm & Haas Acrysol RM 825/RM 2020 NPR, Rohm & Hass Acrysol SCT 275/RM 2020 NPR, Aqualon NLS 200/NHS 300, Elementis Rheolate 255/350 and Cognis DSX 1514/DSX 3075. The relative composition of low shear to high shear thickener in each paint was formulated to obtain a final approximate Stormer viscosity of between 90-100 KU and an ICI viscosity of 1-2 Poise (as per ASTM D562 and D4287).

Formulations

Case 1: Deep Tint Low VOC Eggshell with Dow UCAR 300

| Pounds | Gallons | Component | Vendor | Use |
|---|---|---|---|---|
| 236.6 | 28.4 | Water | | Solvent |
| 1 | 0.1 | Cellosize ER-4400 | Dow Chemical | Thickener |
| 2 | 0.1 | Sodium Carbonate | | Base |
| 2 | 0.3 | Dapro DF 7010 | Elementis | Defoamer |
| | | | Spec. | |
| 9 | 1.0 | Tamol 731 | Rohm & Haas | Dispersant |
| 2 | 0.2 | Triton CF10 | Rohm & Haas | Surfactant |
| 40 | 1.2 | Ti02 (R706) | Dupont | TiO2 |
| 176 | 8.1 | Minex 7 | Unimin | Filler |
| 1.5 | 0.2 | Kathon LX | Rohm & Haas | Biocide |

High Speed (3-4K) - 15-30 mins

| | | | | |
|---|---|---|---|---|
| 6.5 | 0.8 | Texanol | Eastman | Coalescent |
| 395 | 44.4 | UCAR 300 | Dow Chemical | Latex |
| 1.5 | 0.2 | Dapro DF 7010 | Elementis | Defoamer |
| | | | Spec. | |

Hold for Viscosity Adjustment

| | | | | | |
|---|---|---|---|---|---|
| | 75.75 | 8.9 | Associative Thickeners + Water | Various | Thickener |
| Totals | 948.9 | 93.9 | | | |

Case 2: Deep Tint Eggshell Moderate VOC with Dow UCAR 625

| Pounds | Gallons | Component | Vendor | Use |
|---|---|---|---|---|
| 75.0 | 9.0 | Water | | Solvent |
| 1.0 | 0.1 | Nuosept 95 | ISP industries | Biocide |
| 2.0 | 0.3 | Drewplus L464 | Drew Industrial | Defoamer |
| 1.0 | 0.1 | Triton N-57 | Rohm & Haas | Surfactant |
| 7.0 | 0.8 | Tamol 731 | Rohm & Haas | Dispersant |
| 25.0 | 0.8 | TiPure R706 | Dupont | TiO2 |
| 118.0 | 5.4 | Minex 7 | Unimin | Filler |
| 82.0 | 3.6 | Microwhite 25 | | Filler |

High Speed (3-4K) - 15-30 mins

| | | | | |
|---|---|---|---|---|
| 400.0 | 45.4 | UCAR 625 | Dow Chemical | Latex |
| 16.0 | 2.0 | Texanol | | Coalescent |
| 20.0 | 2.2 | Ethylene Glycol | | Solvent |
| 3.0 | 0.4 | Ammonium hydroxide | | Base |
| 2.0 | 0.3 | Drewplus L464 | Drew Industrial | Defoamer |

Hold for Viscosity Adjustment

| | | | | | |
|---|---|---|---|---|---|
| | 249.0 | 28.5 | Associative Thickeners + Water | Various | Thickener |
| Totals | 1001 | 98.9 | | | |

Case 3: Deep Tint Eggshell Moderate VOC with Rohm & Haas ML-200

| Pounds | Gallons | Component | Vendor | Use |
|---|---|---|---|---|
| 75.0 | 9.0 | Water | | Solvent |
| 1.0 | 0.1 | Nuosept 95 | ISP industries | Biocide |
| 2.0 | 0.3 | Drewplus L464 | Drew Industrial | Defoamer |
| 1.0 | 0.1 | Triton N-57 | Rohm & Haas | Surfactant |
| 7.0 | 0.8 | Tamol 731 | Rohm & Haas | Dispersant |
| 25.0 | 0.8 | TiPure R706 | Dupont | TiO2 |
| 118.0 | 5.4 | Minex 7 | Unimin | Filler |
| 82.0 | 3.6 | Microwhite 25 | | Filler |

High Speed (3-4K) - 15-30 mins

| | | | | |
|---|---|---|---|---|
| 29.6 | 3.6 | Water | | |
| 370.4 | 41.4 | Rhoplex ML-200 | Rohm & Haas | Latex |
| 16.0 | 2.0 | Texanol | | Coalescent |
| 20.0 | 2.2 | Ethylene Glycol | | Solvent |
| 3.0 | 0.4 | Ammonium hydroxide | | Base |
| 2.0 | 0.3 | Drewplus L464 | Drew Industrial | Defoamer |

Hold for Viscosity Adjustment

| | | | | | |
|---|---|---|---|---|---|
| | 249.0 | 28.5 | Associative Thickeners + Water | Various | Thickener |
| Totals | 1001.0 | 98.4 | | | |

Case 4: Deep Tint Low VOC Semi-Gloss with BASF Optive 130

| Pounds | Gallons | Component | Vendor | Use |
|---|---|---|---|---|
| 75.8 | 9.1 | Water | | Solvent |
| 1.0 | 0.1 | Cellosize 4400 | Dow | Thickener |
| 2.0 | 0.3 | Ammonium hydroxide | | Base |
| 2.0 | 0.3 | Dapro DF 7010 | Elementis | Defoamer |
| 3.5 | 0.4 | Tamol 731 | Rohm & Haas | Dispersant |
| 2.0 | 0.2 | Triton CF10 | Rohm & Haas | Surfactant |
| 25.3 | 0.8 | Ti02 (R706) | Dupont | TiO2 |
| 35.4 | 1.6 | Polygloss 90 | | |
| 1.0 | 0.1 | Nuosept 95 | ISP Industries | Biocide |

High Speed (3-4K) - 15-30 mins

| | | | | |
|---|---|---|---|---|
| 45.2 | 5.4 | Water | | |
| 506.9 | 57.3 | Optive 130 | BASF | Latex |
| 8.0 | 1.0 | Texanol | Eastman | Solvent |

Hold for Viscosity Adjustment

| | | | | | |
|---|---|---|---|---|---|
| | 195.6 | 23.4 | Associative Thickeners + Water | Various | Thickener |
| Totals | 903.7 | 99.9 | | | |

Case 5: Deep Tint Low VOC Semi-Gloss with DSM Neoresins Neocryl XK-90

| Pounds | Gallons | Component | Vendor | Use |
|---|---|---|---|---|
| 75.8 | 9.1 | Water | | Solvent |
| 1.0 | 0.1 | Cellosize 4400 | Dow | Thickener |
| 2.0 | 0.3 | Ammonium hydroxide | | Base |
| 2.0 | 0.3 | Dapro DF 7010 | Elementis | Defoamer |
| 3.5 | 0.4 | Tamol 731 | Rohm & Haas | Dispersant |
| 2.0 | 0.2 | Triton CF10 | Rohm & Haas | Surfactant |
| 25.3 | 0.8 | Ti02 (R706) | Dupont | TiO2 |
| 35.4 | 1.6 | Polygloss 90 | | |
| 1.0 | 0.1 | Nuosept 95 | ISP Industries | Biocide |

High Speed (3-4K) - 15-30 mins

| | | | | |
|---|---|---|---|---|
| 587.2 | 67.1 | Neocryl XK-90 | DSM Neoresins | Latex |
| 8.0 | 1.0 | Texanol | Eastman | Solvent |
| 45.2 | 5.4 | Water | | |

Hold for Viscosity Adjustment

| | | | | | |
|---|---|---|---|---|---|
| | 161.1 | 19.1 | Associative Thickeners + Water | Various | Thickener |
| Totals | 904.3 | 100.0 | | | |

As illustrated in Table 2, the ABLBA stabilizing polymer was added to the paint as a viscosity stabilizer. The stabilizing additive was added to the paint formula at the same time that a high shear associative thickener and a low shear associative thickener were added. Various pairs of associative thickeners in combination with the ABLBA stabilizing polymer were tested. The pair thickeners were Rohm & Haas Acrysol RM 825/RM 2020 NPR, Rohm & Haas Acrysol SCT 275/RM 2020 NPR, Aqualon NLS 200/NHS 300, Elementis Rheolate 255/350 and Cognis DSX 1514/DSX 3075. The ABLBA stabilizing additive was based on the reaction of 2-hexyl-decyl/EO (50) with HDI. The thickeners and concentrations are listed for each resin systems having large particle sizes. The concentration of the stabilizer was 0.5 wt. %. and the colorant was Colortrend 888 Lampblack @ 12 fl. oz/gal. No attempt was made to optimize the stabilizer concentration.

As shown in Table 2, the ABLBA stabilizing polymer reduced the amount of viscosity decrease upon the addition of colorant to the paint formulation compared to formulations without the ABLBA stabilizing polymer. For some test formulations, the ABLBA stabilizing polymer slightly increased the base viscosity of the paint but reduced the degree of viscosity decrease on colorant addition. In other instances, there was also a marked decrease in the base viscosity of the paint formulation when the ABLBA polymer was added. This effect can be minimized by using a different ABLBA stabilizing polymer.

The data in Table 2 illustrates the viscosity color stability value, Δη, for formulations having a large particle size resin, greater than 200 nm. For the purposes of this application, viscosity color stability means the difference in Stormer viscosity between the 24 hours color tinted formulation and the formulation before tinting after the addition of up to 12 fl. oz. of Colortrend 888 Lampblack per gallon of paint. For a paint formulation having a resin with a particle size greater than 200 nm, the viscosity color stability may range from −10 KU units up to +10 KU units. In one embodiment, the viscosity color stability may range from −10 KU units up to −5 KU units. In another embodiment, the viscosity color stability may range from −5 KU units up to 5 KU units. In yet another embodiment, the viscosity color stability may range from 0 KU up to 10 KU units.

Table 3 shows the results of the ABLBA stabilizing additive to paints for a small particle resin, Optive 130. The concentration of the stabilizer was 0.5 wt. %. and the colorant was Colortrend 888 Lampblack @ 12 fl. oz per gallon of paint. The formulations also contain a commercial high shear associative thickener and a commercial low shear associative thickener. The pair thickeners were Rohm & Haas Acrysol RM 825/RM 2020 NPR, Rohm & Haas Acrysol SCT 275/RM 2020 NPR, Aqualon NLS 200/NHS 300, and Cognis DSX 1514/DSX 3075. The results in Table 3 illustrate that for formulations having small particle resins, the ABLBA stabilizing polymer increased the viscosity of the base paint upon addition of the stabilizing polymer and the addition of colorant resulted in a decrease in viscosity. For a paint formulation having a resin with a particle size less than 200 nm, the viscosity color stability may range from −35 KU units up to −15 KU units. In one embodiment, the viscosity color stability may range from −30 KU units up to −20 KU units. In another embodiment, the viscosity color stability may range from −25 KU units up to −20 KU units.

TABLE 2

| | | KU Builder | | ICI Builder | | η before tinting | | η 1 hr after tinting | | η 24 hr after tinting | | | |
|---|---|---|---|---|---|---|---|---|---|---|---|---|---|
| | | | Conc. | | Conc. | Stormer | ICI | Stormer | ICI | Stormer | ICI | Δη | |
| Resin | | Name | wt. % | Name | wt. % | (KU) | (P) | (KU) | (P) | (KU) | (P) | Stormer | ICI |
| UCAR 300 | Control | RM 825 | 2.25 | RM 2020 | 2 | 91.6 | 1.13 | 70.0 | 1.00 | 75.6 | 1.09 | −16 | −0.04 |
| Case 1 | w/additive | RM 825 | 2.25 | RM 2020 | 2 | 105.0 | 1.83 | 101.0 | 2.41 | 112.6 | 2.06 | 7.6 | 0.24 |
| | Control | SCT 275 | 2.5 | RM 2020 | 2 | 89.3 | 1.06 | 65.9 | 0.70 | 68.7 | 0.76 | −20.6 | −0.30 |
| | w/additive | SCT 275 | 2.5 | RM 2020 | 2 | 107.3 | 1.71 | 96.4 | 2.18 | 107.2 | 2.04 | −0.1 | 0.33 |
| | Control | NLS 200 | 1.85 | NHS 300 | 1.5 | 95.7 | 1.66 | 67.0 | 0.93 | 72.4 | 1.15 | −23.3 | −0.51 |
| | w/additive | NLS 200 | 1.85 | NHS 300 | 1.5 | 119.7 | 1.66 | 105.0 | 2.74 | 119.7 | 2.53 | 0 | 0.87 |
| | Control | DSX 1514 | 1.2 | DSX 3075 | 1.25 | 89.7 | 1.48 | n/a | n/a | 77.2 | 0.93 | −12.5 | −0.55 |
| | w/additive | DSX 1514 | 1.2 | DSX 3075 | 1.25 | 100.3 | 1.51 | n/a | n/a | 108.4 | 2.13 | 8.1 | 0.62 |
| UCAR 625 | Control | RM 825 | 3 | RM 2020 | 2 | 100.0 | 1.40 | 79.0 | 1.51 | 78.6 | 1.23 | −21.4 | −0.17 |
| Case 2 | w/additive | RM 825 | 3 | RM 2020 | 2 | 103.0 | 2.13 | 102.0 | 2.73 | 102.4 | 2.08 | −0.6 | −0.05 |
| | Control | SCT 275 | 2.25 | RM 2020 | 2.25 | 86.0 | 0.85 | 62.0 | 0.66 | 62.4 | 0.53 | −23.6 | −0.32 |
| | w/additive | SCT 275 | 2.25 | RM 2020 | 2.25 | 93.7 | 2.08 | n/a | n/a | 88.8 | 2.13 | −4.9 | 0.05 |
| | Control | NLS 200 | 2.5 | NHS 300 | 0.8 | 93.7 | 1.38 | 69.0 | 0.86 | 68.8 | 0.58 | −24.9 | −0.80 |
| | w/additive | NLS 200 | 2.5 | NHS 300 | 0.8 | 104.3 | 1.99 | 98.0 | 1.38 | 99.1 | 1.81 | −5.2 | −0.18 |
| | Control | DSX 1514 | 1 | DSX 3075 | 2.5 | 85.0 | 0.83 | 67.0 | 0.95 | 66.3 | 0.83 | −18.7 | 0.01 |
| | w/additive | DSX 1514 | 1 | DSX 3075 | 2.5 | 83.0 | 1.23 | 85.0 | 1.86 | 85.0 | 1.53 | 2 | 0.30 |
| ML-200 | Control | RM 825 | 0.9 | RM 2020 | 2 | 89.0 | 0.42 | 58.6 | 0.41 | 58.9 | 0.50 | −30.1 | 0.08 |
| Case 3 | w/additive | RM 825 | 0.9 | RM 2020 | 2 | 82.0 | 0.68 | 71.0 | 0.98 | 76.6 | 1.07 | −5.4 | 0.40 |
| | Control | SCT 275 | 1.25 | RM 2020 | 2 | 91.8 | 0.53 | 58.4 | 0.55 | 59.7 | 0.37 | −32.1 | −0.16 |
| | w/additive | SCT 275 | 1.25 | RM 2020 | 2 | 85.6 | 0.84 | 71.2 | 1.08 | 77.6 | 1.49 | −8 | 0.65 |
| | Control | NLS 200 | 0.75 | NHS 300 | 1.5 | 93.0 | 0.74 | 59.0 | 0.52 | 59.9 | 0.51 | −33.1 | −0.23 |
| | w/additive | NLS 200 | 0.75 | NHS 300 | 1.5 | 88.4 | 0.91 | 72.2 | 1.13 | 79.0 | 1.18 | −9.4 | 0.27 |
| | Control | DSX 1514 | 0.5 | DSX 3075 | 1.5 | 93.2 | 0.59 | n/a | n/a | 60.6 | 0.48 | −32.6 | −0.11 |
| | w/additive | DSX 1514 | 0.5 | DSX 3075 | 1.5 | 85.6 | 1.09 | n/a | n/a | 80.4 | 1.24 | −5.2 | 0.15 |

TABLE 3

| | | KU Builder | | ICI Builder | | η before tinting | | η 1 hr after tinting | | η 24 hr after tinting | | | |
|---|---|---|---|---|---|---|---|---|---|---|---|---|---|
| | | | Conc. | | Conc. | Stormer | ICI | Stormer | ICI | Stormer | ICI | Δη | |
| Resin | | Name | wt. % | Name | wt. % | (KU) | (P) | (KU) | (P) | (KU) | (P) | Stormer | ICI |
| Optive | Control | RM 825 | 1.0 | RM 2020 NPR | 5 | 107.8 | 1.56 | n/a | n/a | 74 | 1.25 | −33.8 | −0.31 |
| 130 | w/additive | RM 825 | 1.0 | RM 2020 NPR | 5 | 111.4 | 1.76 | n/a | n/a | 91.2 | 1.94 | −20.2 | 0.18 |
| Case 4 | Control | SCT 275 | 1.3 | RM 2020 NPR | 5 | 111.8 | 1.35 | n/a | n/a | 73 | 0.88 | −38.8 | −0.47 |
| | w/additive | SCT 275 | 1.3 | RM 2020 NPR | 5 | 115.1 | 1.84 | n/a | n/a | 91.6 | 1.98 | −23.5 | 0.14 |
| | Control | NLS 200 | 1.0 | NHS 300 | 3.2 | 96.8 | 1.02 | n/a | n/a | 59.6 | 0.29 | −37.2 | −0.73 |
| | w/additive | NLS 200 | 1.0 | NHS 300 | 3.2 | 115.8 | 1.18 | n/a | n/a | 81.3 | 1.18 | −34.5 | 0.00 |
| | Control | DSX 1514 | 0.55 | DSX 3075 | 3.2 | 103.4 | 0.66 | n/a | n/a | 66.1 | 0.42 | −37.3 | −0.24 |
| | w/additive | DSX 1514 | 0.55 | DSX 3075 | 3.2 | 107.4 | 0.90 | n/a | n/a | 82.5 | 1.03 | −24.9 | 0.13 |

In another embodiment for small particle resins less than 200 nm, the ABLBA polymer may be used as a low shear associative thickener, in conjunction with a high shear associative thicker, while also providing color stabilization. Table 4 compares the results in two small particle resin paints using the polymer of 2-hexyl-decyl/EO (50) linked with HDI at the quantities shown in the table. For comparison, a commercial low shear thickener, DSM XK-90, was used. The colorant was Colortrend 888 Lampblack used at 12 fl. oz. per gallon of paint. By using the stabilizing ABLBA polymers as a low shear associative thickener (25% actives in the water:butylcarbitol mixture), the viscosity loss upon tinting was drastically reduced. For a paint formulation having a resin with a particle size less than 200 nm, a high shear associative thickener and the ABLBA stabilizing polymer, the viscosity color stability may range from −15 KU units up to 0 KU units. In one embodiment, the viscosity color stability may range from −10 KU units up to 0 KU units.

TABLE 4

| | | | | | Before Tinting | | After Tinting | | | | | |
|---|---|---|---|---|---|---|---|---|---|---|---|---|
| | | | | | η before tinting | | η 1 hr after tinting | | η after tinting | | | |
| | High Shear | Conc. | Low Shear | Conc. | Stormer | ICI | Stormer | ICI | Stormer | ICI | Eη | |
| Resin | Builder | wt. % | Builder | wt. % | (KU) | (P) | (KU) | (P) | (KU) | (P) | Stormer | ICI |
| Optive 130 | Rheolate 350 | 3.0 | Additive | 3.0 | 99.6 | 0.99 | 87.2 | 1.99 | 92.7 | 1.93 | −6.9 | 0.94 |
| | RM 2020 NPR | 4.0 | Additive | 3.0 | 89.7 | 1.08 | n/a | n/a | 77.2 | 1.29 | −12.5 | 0.21 |
| XK-90 | RM 2020 NPR | 3.0 | RM 825 | 1.0 | 131.9 | 1.41 | 87.6 | 0.97 | 95 | 1.11 | −36.9 | −0.30 |
| | Rheolate 350 | 3.0 | Additive | 2.5 | 98.2 | 1.27 | 95.7 | 1.77 | 96 | 1.28 | −2.2 | 0.01 |

Table 5 compares the effect of the diisocyanate group on the stabilization of an ABLBA additive where A is 2-hexyl-decanol and B is ethylene oxide having 40 EO units. Deep tint base Case 1 was studied with Rheolate 255 without/with stabilizing additive. The stabilizing additive was used at a concentration of 0.75 wt. The colorant was Colortrend 888 Lampblack used at 12 fl. oz. per gallon of paint. The data shows that the coupling agent has minimal impact when the polymer is used as a stabilizer in a large particle latex paint.

TABLE 5

| | Base Viscosity | | Tinted Viscosity | | | |
|---|---|---|---|---|---|---|
| Diisocyanate | KU | ICI | KU | ICI | KU | ICI |
| Control | 101.7 | 1.9 | 67 | 0.8 | −34.7 | −1.1 |
| (no Additive) | | | | | | |
| HDI | 104.7 | 4 | 102.6 | 3.1 | −2.1 | −0.1 |
| TMDI | 100 | 2.5 | 93 | 2.4 | −7 | −0.1 |
| TMXDI | 103.8 | 3.4 | 99.6 | 2.8 | −4.2 | −0.2 |
| IPDI | 101 | 3.1 | 93 | 2.6 | −8 | −0.2 |

HDI = Hexamthylene diisocyanate
TMDI = Trimethylhexamethylene diisocyanate
TMXDI = Tetramethylxylyl diisocyanate
IPDI = Isophorone diisocyanate

Table 6 shows the results of the addition of the stabilizer based on the benzophenone tetracarboxylic dianhydride. The Deep tint base Case 1 was studied with Rheolate 255 without/with stabilizing additive. The ABLBA stabilizing additive based on 2-hexyl-decanol with 50 EO units at a concentration of 0.75 wt. %. The colorant was Colortrend 888 Lampblack used at 12 fl. oz. per gallon of paint. In this case, the ABLBA polymer appears to provide slightly less viscosity color stability than the diisocyanate linked polymers which may be due to the diacid in the product.

TABLE 6

| | Base Viscosity | | Tinted Viscosity | | | |
|---|---|---|---|---|---|---|
| Example | KU | ICI | KU | ICI | ΔKU | ΔICI |
| Control | 101.7 | 1.9 | 67 | 0.8 | −34.7 | −1.1 |
| (no Additive) | | | | | | |
| BTD-A | 100 | 2.8 | 92 | 2.1 | −8 | −0.7 |
| BTD-B | 95.2 | 2.2 | 82.2 | 1.6 | −13 | −0.6 |

BTD = benzophenone tetracarboxylic dianhydride

The example with BTD-A did not have any excess low molecular weight AB unit (alkyl ethoxylate) while the BTD-B had approximately 10% residual AB unit unreacted with the linking agent. The presence of the unreacted AB unit decreases the color stabilization. Tables 7 and 8 demonstrate the effect of hydrophobe and ethoxylate molecular weight (from Table 1), where the alkyl ethoxylates, of Table 1, were linked by HDI. In these examples, the latex paint case 2 was thickened with Rheolate 255 (3%) with and without additives. The additive concentration was 0.75%. The colorant was Colortrend 888 Lampblack used at 12 fl. oz. per gallon of paint.

TABLE 7

| | Before Tinting | | After Tinting | | | |
|---|---|---|---|---|---|---|
| | Stormer | | Stormer | | | |
| Example | (KU) | ICI (P) | (KU) | ICI (P) | ΔKU | ΔICI |
| 1 | 95 | 3.2 | 84.3 | 2.8 | −10.8 | −0.4 |
| 4 | 93 | 2.8 | 81.3 | 2.4 | −11.7 | −0.4 |
| 8 | 100.5 | 2.6 | 81.7 | 1.4 | −18.8 | −1.2 |
| 9 | 97.9 | 2.6 | 87.5 | 1.3 | −10.4 | −1.3 |
| Control | 101.7 | 1.9 | 67 | 0.8 | −34.7 | −1.1 |

TABLE 8

| | Before Tinting | | After Tinting | | | |
|---|---|---|---|---|---|---|
| | Stormer | | Stormer | | | |
| Example | (KU) | ICI (P) | (KU) | ICI (P) | ΔKU | ΔICI |
| Control | 96.2 | 1.33 | 74.2 | 1.48 | −22 | 0.15 |
| 7 | 105.4 | 2.05 | 105.2 | 2.52 | −0.2 | 0.47 |
| 6 | 99.8 | 1.8 | 91.5 | 1.94 | −8.3 | 0.14 |
| 3 | 94 | 1.48 | 82.5 | 2.3 | −11.5 | 0.82 |
| 2 | 100 | 2.08 | 95.3 | 2.16 | −4.7 | 0.08 |

As seen in Tables 7 and 8, the structure and molecular weight of the stabilizing polymer has an effect on the rheology of the paint and the stabilizing effect. ABLBA polymers based on A components which are straight chain, branched or cyclic aliphatic compounds all provide viscosity color stabilization. Higher AB molecular weights lead to viscosity build in the base paint. Hydrophobe length is also important where shorter lengths reduce base paint viscosity. Furthermore, the low and high shear viscosity can be influenced differently based on the structure.

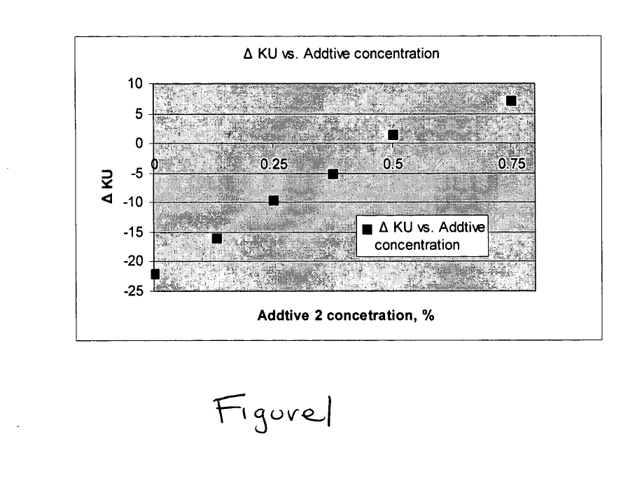

Table 9 and FIG. 1 illustrate the effect of stabilizing additive concentration on the degree of viscosity change upon addition of colorant. In these examples, the latex paint case 2 was thickened with Rheolate 255 (3%) with and without additives. The additive concentration was 0.75%. The colorant was Colortrend 888 Lampblack used at 12 fl. oz. per gallon of paint. The data show that amount of viscosity stabilization is proportional to the amount of stabilizer; increasing the amount of ABLBA stabilizer polymer decreases the effect of the colorant on the viscosity of the paint.

TABLE 9

| % Additive 2 | before tinting | | after tinting | | | |
|---|---|---|---|---|---|---|
| concentration, | KU | ICI | KU | ICI | ΔKU | ΔICI |
| 0 | 96.2 | 1.33 | 74.2 | 1.48 | −22 | 0.15 |
| 0.13 | 96 | 1.55 | 80.1 | 1.28 | −15.9 | −0.27 |
| 0.25 | 97.1 | 2.03 | 87.6 | 1.73 | −9.5 | −0.3 |
| 0.375 | 102.2 | 2.42 | 97.2 | 2.28 | −5 | −0.14 |
| 0.5 | 101.3 | 2.18 | 102.9 | 2.35 | 1.6 | 0.17 |
| 0.75 | 104.6 | 2.55 | 111.8 | 3.25 | 7.2 | 0.7 |

The present disclosure may be embodied in other specific forms without departing from the spirit or essential attributes of the invention. Accordingly, reference should be made to the appended claims, rather than the foregoing specification, as indicating the scope of the disclosure. Although the foregoing description is directed to the preferred embodiments of the disclosure, it is noted that other variations and modification will be apparent to those skilled in the art, and may be made without departing from the spirit or scope of the disclosure.

What is claimed:

1. A water-borne latex paint system, comprising:
(a) a base paint,
(b) at least one associative thickener,
(c) a colorant compound, and
(d) at least 0.1% dry weight of a block copolymer ABLBA composition.

2. The system of claim 1, wherein the ABLBA-type polymer includes: an A component comprising a hydrophobic group A; a B component comprising a hydrophilic polymer B; and an L component comprising a linking group.

3. The system of claim 1, wherein the ABLBA-type polymer includes: an A component comprising a monomer unit containing a moiety selected from the group consisting of an alkyl group, an aryl group or an alkyl aryl group; a B component comprising a polyethylene oxide polymer or a polyethylene-polypropylene oxide copolymer; and an L component selected from one or more of the following linking units: a dianhydride unit and a diisocyanate unit.

4. The system of claim 3, wherein the A component includes one or more of the following: linear C₁₀-C₂₂ alcohols or branched C₁₂-C₂₄ alcohols and mixtures thereof.

5. The system of claim 4, wherein the A component includes one or more of the following: 2-butyl-octanol, 2-hexyl-decanol, 2-octyl-dodecanol, 2-isoheptyl-7-methyl-undecanol, 2-(2,4,4-trimethylbutyl)-6,8,8-trimethyl-nonanol, and mixtures thereof.

6. The system of claim 3, wherein the polyethylene oxide polymer has from 25 to 100 ethylene oxide repeat units.

7. The system of claim 3, wherein the polyethylene-polypropylene oxide copolymer has a total number of repeat units ranging from 25 to 75 and up to 10 propylene oxide units.

8. The system of claim 7, wherein the polyethylene-polypropylene oxide copolymer has a number average molecular weight less than 2500.

9. The system of claim 3, wherein the linking unit comprises a diisocyanate linking unit.

10. The system of claim 9, wherein the diisocyanate linking unit is selected from compounds selected from the group consisting of: hexamethylene diisocyanate, trimethyl hexamethylene diisocyanate, isophorone diisocyanate, tetramethyl xylene diisocyanate, and 4,4-methylene bis(cyclohexylisocyanate).

11. The system of claim 3, wherein the A component comprises 2-hexyl decanol, the B component comprises polyethylene oxide having 50 ethylene oxide units and the L component comprises hexamethylene diisocyanate.

12. The system of claim 3, wherein the resin comprises a hydrophobic resin or a hydrophilic resin.

13. The system of claim 12, wherein the resin includes one or more of the following: a vinyl acrylic resin, a vinyl acetate ethylene resin, an acrylic resin and a styrene acrylic resin.

14. The system of claim 12, wherein the resin has a particle size greater than 200 nm.

15. The system of claim 14, wherein the at least one associative thickener includes a low shear associative thickener and a high shear associative thickener.

16. The system of claim 12, wherein the resin has a particle size less than 200 nm.

17. The system of claim 16, wherein the at least one associative thickener includes a high shear associative thickener.

18. The system of claim 3, wherein the system contains less than 0.01 wt. % of a second polymer containing at least one hydrophilic group having a number average molecular weight of at least 1000 and only one hydrophobic group.

19. A method of formulating a water-borne latex paint system, comprising:
(a) adding to a base paint, at least one associative thickener and a colorant compound; and
(b) further adding at least 0.1% dry weight of a block copolymer ABLBA composition.

20. The method of claim 19, wherein the ABLBA-type polymer includes: an A component comprising a hydrophobic group A; a B component comprising a hydrophilic polymer B; and an L component comprising a linking group.

21. The method of claim 19, wherein the ABLBA-type polymer includes: an A component comprising a monomer unit containing a moiety selected from the group consisting of an alkyl group, an aryl group or an alkyl aryl group; a B component comprising a polyethylene oxide polymer or a polyethylene-polypropylene oxide copolymer; and an L component selected from one or more of the following linking units: a dianhydride unit and a diisocyanate unit.

22. The method of claim 21, wherein the A component includes one or more of the following: linear C₁₀-C₂₂ alcohols or branched C₁₂-C₂₄ alcohols and mixtures thereof.

23. The method of claim 22, wherein the A component includes one or more of the following: 2-butyl-octanol, 2-hexyl-decanol, 2-octyl-dodecanol, 2-isoheptyl-7-methyl-undecanol, 2-(2,4,4-trimethylbutyl)-6,8,8-trimethyl-nonanol, and mixtures thereof.

24. The method of claim 22, wherein the polyethylene oxide polymer has from 25 to 100 ethylene oxide repeat units.

25. The method of claim 22, wherein the polyethylene-polypropylene oxide copolymer has a total number of repeat units ranging from 25 to 75 and up to 10 propylene oxide units.

26. The method of claim 25, wherein the polyethylene-polypropylene oxide copolymer has a number average molecular weight less than 2500.

27. The method of claim 22, wherein the linking unit comprises a diisocyanate linking unit.

28. The method of claim 27, wherein the diisocyanate linking unit is obtained from compounds selected from the group consisting of: hexamethylene diisocyanate, trimethyl hexamethylene diisocyanate, isophorone diisocyanate, tetramethyl xylene diisocyanate, and 4,4-methylene bis(cyclohexylisocyanate).

29. The method of claim 27, wherein the A component comprises 2-hexyl-decanol, the B component comprises polyethylene oxide having 50 ethylene oxide units and the L component comprises hexamethylene diisocyanate.

30. The method of claim 22, wherein the resin comprises a hydrophobic resin or a hydrophilic resin.

31. The method of claim 30, wherein the resin includes one or more of the following: a vinyl acrylic resin, a vinyl acetate ethylene resin, an acrylic resin and a styrene acrylic resin.

32. The method of claim 30, wherein the resin has a particle size greater than 200 nm.

33. The system of claim 32, wherein the at least one associative thickener includes a low shear associative thickener and a high shear associative thickener.

34. The method of claim 30, wherein the resin has a particle size less than 200 nm.

35. The method of claim 34, wherein the at least one associative thickener includes a high shear associative thickener.

36. A polymer chemical which is made by reacting:
a) a monomer unit containing a moiety selected from the group consisting of an alkyl group, an aryl group or an alkyl aryl group;
b) a polyethylene oxide polymer or a polyethylene-polypropylene oxide copolymer; and
c) an L component selected from one or more of the following linking unit: a dianhydride unit and a diisocyanate unit.

37. The polymer chemical of claim 36, wherein the A component includes one or more of the following: linear C₁₀-C₂₂ alcohols or branched C₁₂-C₂₄ alcohols and mixtures thereof.

38. The polymer chemical of claim 37, wherein the A component includes one or more of the following: 2-butyl-octanol, 2-hexyl-decanol, 2-octyl-dodecanol, 2-isoheptyl-7-methyl-undecanol, 2-(2,4,4-trimethylbutyl)-6,8,8-trimethyl-nonanol, and mixtures thereof.

39. The polymer chemical of claim 36, wherein the polyethylene oxide polymer has from 25 to 100 ethylene oxide repeat units.

40. The polymer chemical of claim 36 wherein the polyethylene-polypropylene oxide copolymer has a total number of repeat units ranging from 25 to 75 and up to 10 propylene oxide units.

41. The polymer chemical of claim 36, wherein the linking unit comprises a diisocyanate linking unit.

42. The polymer chemical of claim 41, wherein the diisocyanate linking unit is obtained from compounds selected from the group consisting of: hexamethylene diisocyanate, trimethyl hexamethylene diisocyanate, isophorone diisocyanate, tetramethyl xylene diisocyanate, and 4,4-methylene bis(cyclohexylisocyanate).

43. The polymer chemical of claim 36, wherein the monomer unit comprises hexyl decanol, the polyethylene oxide has 50 ethylene oxide units and the linking unit comprises hexamethylene diisocyanate.
